(19) United States
(12) Patent Application Publication
(10) Pub. No.: US 2021/0073801 A1
(43) Pub. Date: Mar. 11, 2021

(54) INCOGNITO TRANSACTIONS

(71) Applicant: MASTERCARD INTERNATIONAL INCORPORATED, Purchase, NY (US)

(72) Inventor: Ahmed HOSNY, Dublin (IE)

(21) Appl. No.: 16/564,658

(22) Filed: Sep. 9, 2019

(51) Int. Cl. G06Q 20/38; G06F 21/62

(52) U.S. Cl. CPC G06Q 20/383; G06F 21/6254

(57) ABSTRACT

Incognito transactions can be provided by, in response to receiving a signal to initiate the incognito session, establishing parameters for an active incognito session. A payment request from a merchant may be received during the active incognito session. In response to receiving the payment request, an incognito payment request can be communicated to an issuer, where the incognito payment request includes at least the payment request and an indication of an incognito session. A payment result from the issuer can be received during the active incognito session. In response to receiving the payment result, an incognito payment result can be communicated to the merchant, where the incognito payment result includes at least the payment result and an indication of an incognito session. Stored transaction data can be modified for any transaction that occurred during the active incognito session such that certain details can be obscured.

### BACKGROUND

The General Data Protection Regulation (GPDR) is a regulation in the European Union implemented on May 25, 2018. GPDR deals with data protection and privacy for citizens in the European Union. Among other provisions, the GDPR includes a “right of erasure” (a subset of a larger and older “right to be forgotten”) for data subjects (e.g. customers of businesses) that provides that individuals have the right to request erasure of personal data related to them. This right of erasure extends to financial institutions, and so a customer of a bank or payment network can be allowed to request certain personal data about the customer's purchases be erased.

In particular, there is a lot of data stored for customers of payment card networks. Some or all of this data is subject to various regulations, but there is no implementation to allow a customer to communicate which data they want to be erased in a streamlined way. While the GPDR allows for data subjects to request deletion within 30 days, a proactive solution can be implemented to streamline the process.

### BRIEF SUMMARY

Methods for performing incognito transactions are provided. Incognito transactions can be used to obscure some details about transactions in order to provide privacy for a cardholder. Details can be removed or otherwise obscured from merchant, payment network, issuer, and other institution records. The details that can be removed include date, a reference number for internal use, a transaction detail, a name of the merchant in the transaction, and an amount of the transaction. Methods can leverage existing communication methodology to achieve incognito transactions.

A method for incognito transactions can include receiving a signal to initiate an incognito session. In response to receiving the signal to initiate the incognito session, parameters for an active incognito session for a user can be established. A payment request from a merchant may be received during the active incognito session. In response to receiving the payment request during the active incognito session, an incognito payment request can be communicated to an issuer, the incognito payment request includes at least the payment request from the merchant and an indication of an incognito session for the issuer. A payment result from the issuer can be received during the active incognito session. In response to receiving the payment result during the active incognito session, an incognito payment result can be communicated to the merchant, the incognito payment result includes at least the payment result from the issuer and an indication of an incognito session for the merchant. Stored transaction data can be modified for one or more transactions that occurred during the active incognito session. In some cases, the modification can be deletion or encryption (or other form of obfuscation).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment card process.

FIGS. 2A-2C illustrates example process views for carrying out incognito transactions.

FIGS. 3A-3F illustrate a process for processing transactions during an incognito session.

FIG. 4 illustrates a method for incognito transactions.

FIG. 5A-5D illustrates example payment card statements resulting from incognito card transactions.

FIG. 6 illustrates components of a computing system that may provide an incognito service as described herein.

### DETAILED DESCRIPTION

Methods for performing incognito transactions are provided. Incognito transactions can be used to obscure some details about transactions in order to provide privacy for a cardholder. Details can be removed or otherwise obscured from merchant, payment network, issuer, and other institution records. The details that can be removed include date, a reference number for internal use, a transaction detail, a name of the merchant in the transaction, and an amount of the transaction. Methods can leverage existing communication methodology to achieve incognito transactions.

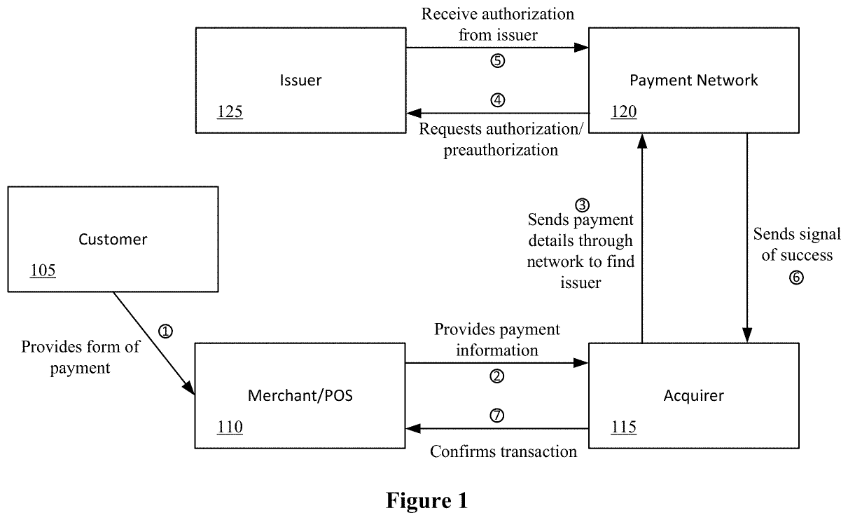

FIG. 1 illustrates an example conventional payment card process. Referring to FIG. 1, in conventional payment card processes, there can be communication between a customer 105, merchant 110, an acquirer 115, a payment network 120, and an issuer 125. These communications can include a payment process using a payment card. The payment process can include payment card authorization, clearing, and settlement. The customer 105 can be the cardholder or a person authorized to use the account corresponding to the cardholder. The merchant 110 can be a provider of goods or services in exchange for payment. The merchant 110 can be physically present at a sale (e.g., as a point of sale terminal) or remote, such as an online retailer. The acquirer 115 can be a party that receives funds on behalf of the merchant 110 in a payment card transaction. The acquirer 115 can be a bank or other institution associated with the merchant 110. The payment network 120 facilitates transactions between merchants and payment card issuers. Examples of payment networks 120 include the Mastercard payment network. An issuer 125 can be a bank or other institution that has an account associated with the customer and which issues the payment card to the customer.

A process of payment card authorization can begin with a customer 105 presenting a form of payment to purchase goods or services as shown in (1). When the form of payment is a physical card or a contactless card (e.g., hosted on a mobile device, and available on an e-wallet), a merchant 110 can receive the payment via a point-of-sale (POS) terminal to obtain information about the form of payment. The POS system can extract information about the form of payment such as the credit card number, confirmation code, and expiration date. Information obtained by the POS system can also include information about the purchase, such as location, amount, goods type, and a form of verification provided. This information may be stored in some form on merchant computing devices. A payment request, comprising at least the information about the form of payment and the information about the purchase, can be provided to an acquirer 115 associated with the merchant 110 as shown in (2). The acquirer 115 can, in turn, provide the payment request to the payment network 120 as shown in (3).

The payment network 120 can identify an issuing bank, or issuer 125, of the customer's form of payment. The transaction can be logged to aid in later processes, such as clearing and settlement. The details of the transaction can also be stored in a transaction details storage, which may be associated with the payment network 120. When the payment network 120 identifies the issuer 125, the payment network 120 can send the payment request and request from the issuer authorization and/or preauthorization on the form of payment, as shown in (4).

The issuer 125 can run the requested authorization or preauthorization. Authorization can entail ensuring that a transaction is legitimate, such as by checking the provided verification, location, and amount. For example, a provided form of verification can be compared against previously given verification (e.g. biometrics or signature) to determine if the customer is a legitimate user for the form of payment. Similarly, an issuer 125 can compare the location against typical spending locations to detect fraudulent charges. Finally, an issuer 125 can determine that a purchase is likely to be too high value to be legitimate and flag the purchase as possibly fraudulent. The authorization can also check to see if the card is currently locked or suspended. Pre-authorization can entail determining that a customer has sufficient credit or account balance to make the transaction. A credit card pre-authorization can be a temporary hold on funds equal to the payment that last for a period of time (e.g., 5 days). During the temporary hold, the funds cannot be used anywhere else, but the charge may not actually show up on the statement of the form of payment. After one or more of these checks are performed, the issuer 125 can accept the transaction and forward a payment result indicating success or failure back to the payment network 120 as shown in (5).

Once the payment result signal is received, the payment network 120 can forward the signal to the acquirer 115 as shown in (6). The acquirer can then forward the signal back to the merchant 110 as shown in (7) to confirm that the transaction has been authorized. Later on, settlement and clearing can occur. In clearing, the payment and transaction information can be double checked for accuracy. In settlement, the issuer 125 can transfer funds to the payment network 120; the payment network 120 can then transfer the funds to the acquirer 115. Once the acquirer 115 receives the funds, the funds can be made available to the merchant 110.

Incognito transactions can be used to obscure some details about transactions in order to provide privacy for a cardholder. An incognito transaction can obscure details about transactions that occur in a given incognito session. This might be useful, for example, when shopping for a gift. Even if another person has access to your account, say a spouse or parent, the other person would be unable to determine the gift if certain details were missing. Certain regulations such as the GDPR either allow for or mandate obscuring of personal data, including customer data. The claimed invention allows the cardholder to communicate which personal data should be obscured. The claimed invention also can use existing processes and framework to allow for incognito transactions with few changes.

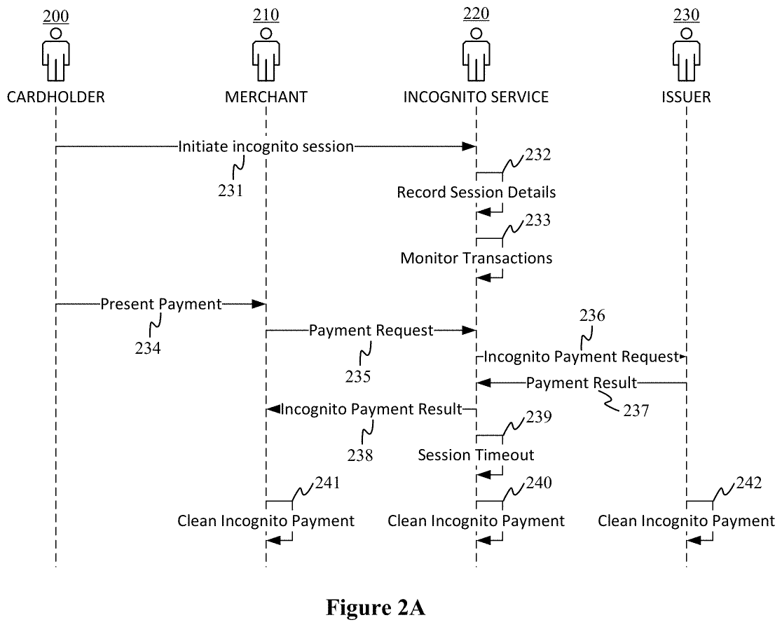

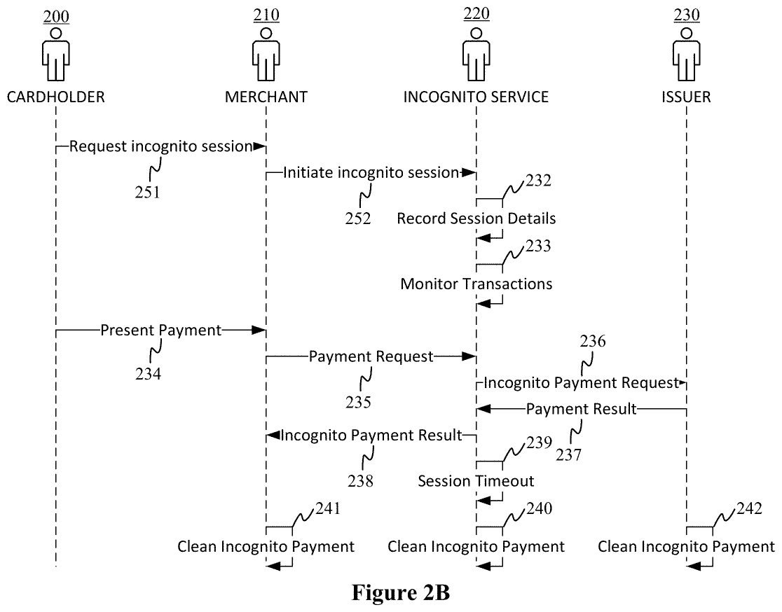

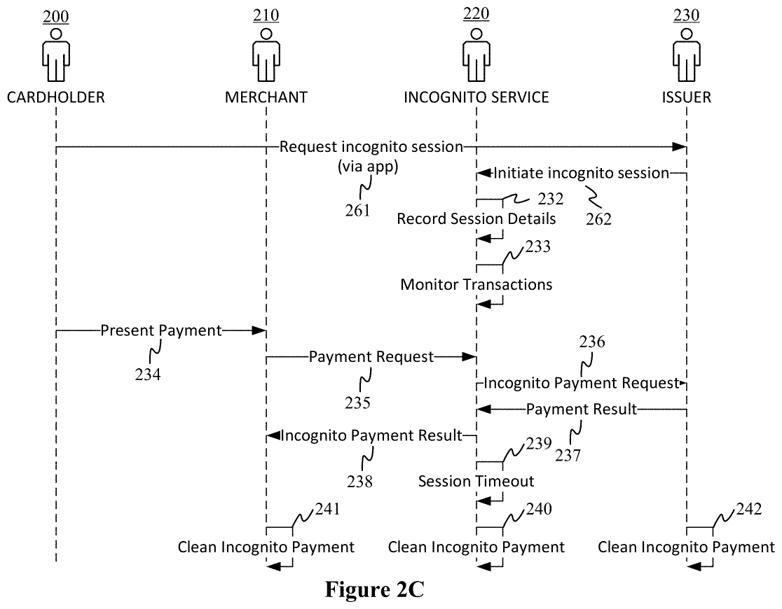

FIGS. 2A-2C illustrates example process views for carrying out incognito transactions. Parties involved in the process can include a Cardholder 200, Merchant 210, Incognito Service 220, and Issuer 230. The Cardholder 200 is anyone associated with the account corresponding to the cardholder. The transmission and handling of payment card transactions can occur as described with respect to FIG. 1 unless noted otherwise. The Incognito Service 220 can be hosted at the payment network 120 as described in FIG. 1, or can be hosted independently, but in communication with payment network 120 such that payment requests and payment results pass therethrough. FIG. 2A illustrates a process view of an incognito session initiated by the Cardholder 200. FIG. 2B illustrates a process view of an incognito session initiated by the Merchant 210. FIG. 2C illustrates a process view of an incognito session initiated by the Issuer 230.

Referring to FIG. 2A, an incognito session can be initiated by a Cardholder 200. The Cardholder 200 can communicate to the Incognito Service 220 a signal to initiate an incognito session (231). The signal can be through an application managed by the Incognito Service or Payment Network, for instance, that allows the Cardholder 200 to provide verification as well as parameters for the incognito session. The application may be accessible via a mobile device. In some cases, the signal can be through a website. The parameters can be communicated to the Incognito Service 220 via data transmitted with the signal to initiate the incognito session. The data transmitted can be parsed by the Incognito Service 220 to determine the parameters for the incognito session. Parameters can be used to determine when the incognito session is active.

For example, a Cardholder 200 may have to provide one or more settings for when an incognito session is active (e.g. either a start and end time, merchant code total number of transactions, or total amount to be spent), accounts on which to initiate an incognito session, and/or types of data to save. That is, a Cardholder 200 can apply the incognito session to all transactions occurring within a certain time frame or a subset of transactions based on amount, location, merchant, and the like.

Once the incognito session has been initiated, the Incognito Service 220 can record (232) the parameters of the incognito session (also referred to as “session details”). The session details can also be stored in a session details storage associated with the Incognito Service 220. The Incognito Service 220 can monitor (233) transactions during an active incognito session to ensure the incognito session is properly conducted. The monitoring can be conducted in communication with a payment network (or as part of the payment network).

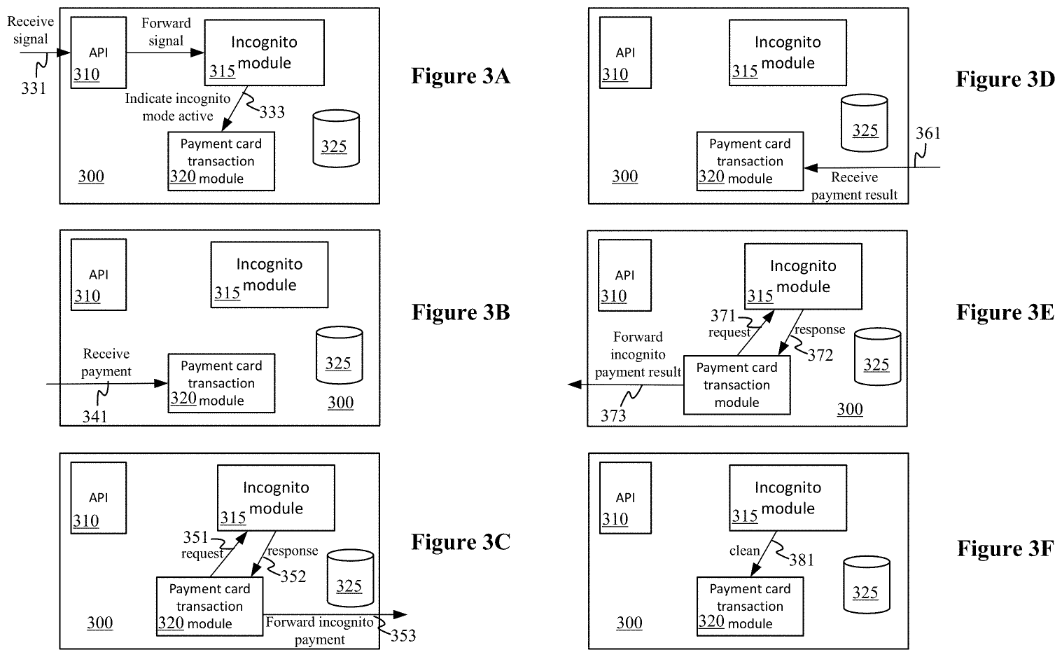

At some time after initiating the incognito session, the Cardholder 200 may initiate a transaction with a Merchant 210 by presenting payment (234). The Merchant 210 can communicate (235) a payment request to the Incognito Service 220, comprising at least the information about the form of payment and the information about the purchase. This communication can ultimately be received by the Incognito Service 220. The communication of the payment request to the Incognito Service 220 can occur as is typical with respect to a payment network, such as described in FIG. 1. For instance, the payment request may be received by an Acquirer that communicates the request to the Incognito Service 220 (or a payment network that includes or communicates the request to the Incognito Service 220). When the Incognito Service 220 receives the payment request (or at least notification of a payment request), the Incognito Service 220 can process the payment request to identify the Issuer 230 for the payment method and communicate an incognito payment request (236) to the Issuer 230, including at least the payment request and an indication of an incognito session for the Issuer 230. Incognito payment processing can be carried out such as described with respect to FIGS. 3A-3F.

The Issuer 230 can then perform typical authorization and/or preauthorization checks. When the Issuer 230 is ready, a payment result can be returned (237) to the Incognito Service 220. When the Incognito Service 220 receives the payment result, the Incognito Service 220 can process the payment result and communicate (238) an incognito payment result to the Merchant 210, including at least the payment result and an indication of an incognito session for the Merchant 210. At this point, the system can return to monitoring transactions (233) until either another payment result is received or the session times out.

At some point later, the incognito session can timeout (239). This timeout can be based on the parameters set during the initiation of the incognito session is active set when the incognito session is initiated, or the incognito session can be manually terminated by the Cardholder 200. For example, the timeout can be based on the date (e.g., a specific date or a certain number of days or other unit of time from initiation).

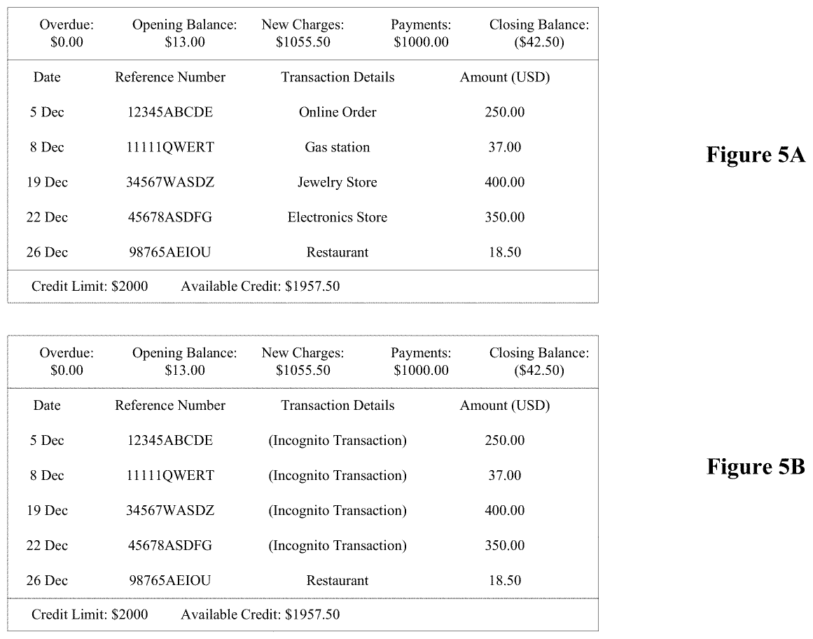

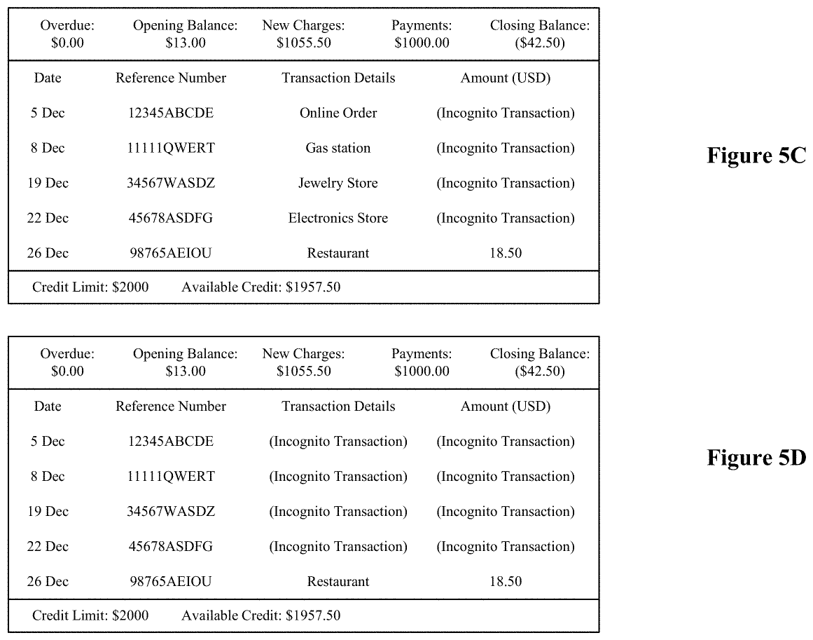

When the Incognito Service 220 processes the session timeout, a clean incognito payment process can be triggered (240). For each incognito payment during the incognito session, the payment details can be altered in some way to fit an amount of data to save specified when the incognito session is initiated. In one implementation, a full data wipe is performed, where all details of the transaction are removed from the transaction details storage in the Incognito Service 220. In another implementation, certain data are removed from the transaction details storage, and others are not removed. For example, the merchant name can be removed but the amount spent can be preserved. In another implementation, some or all of the data can be archived to later allow the Cardholder 200 to recover the data at a later date. Various implementations of payment statements resulting from different clean incognito payment processes can be seen in FIG. 5A-5D. A clean incognito payment process may also be performed independent of a session timeout, for instance in the case of a statement being prepared during an active incognito session.

The clean incognito payment process can also occur at the Merchant 210 and Issuer 230 (241) (242). A request to initiate clean incognito payment processes can be sent by the Incognito Service 220 in response to the session timeout or the Merchant 210 and Issuer 230 can independently initiate the clean incognito payment process at session timeout when the incognito payment request and incognito payment result indicate the parameters for session timeout in addition to the particular details that should be removed or otherwise obfuscated.

Referring to FIG. 2B, the incognito session can also be initiated by the Merchant 210. After receiving (251) a request from the Cardholder 200, the Merchant 210 can send a request (252) to initiate an incognito session to the Incognito Service 220. In some cases, the request for incognito session (received from operation 251) can be made at the time of the transaction initiated by presenting payment (operation 234). The request to initiate an incognito session, as in FIG. 2A, can include details for the incognito session. A Merchant 210 may have more limited ability to define parameters of the incognito session. For instance, the Merchant 210 may only be able to initiate an incognito session for one purchase, or the Merchant 210 may be limited in choices for the amount and types of data to save. In certain implementations, the Cardholder 200 may be contacted to verify that the request to initiate an incognito session is legitimate. Once the request to initiate an incognito session is received by the Incognito Service 220, the process can occur as detailed in FIG. 2A.

Referring to FIG. 2C, the incognito session can also be initiated by the Issuer 230. After receiving a request (261) from the Cardholder 200, the Issuer 230 can send a request to initiate an incognito session (262) to the Incognito Service 220. The request, as in FIG. 2A, can include details for the incognito session, perhaps including a duration and/or types of data to save. In certain implementations, this request can be made by the cardholder 200 via an application managed by the Issuer 230. For example, the application may be a banking institution application. Once the request to initiate an incognito session is received by the Incognito Service 220, the process can occur as detailed in FIG. 2A.

FIGS. 3A-3F illustrate a process for processing transactions during an incognito session. As illustrated in FIGS. 3A-3F, the process for processing transactions during an incognito session can be carried out on a system 300 hosting an Incognito Service such as described with respect to Incognito Service 220 of FIGS. 2A-2C. The Incognito Service may exist within a portion of or communicate with a Payment Network such as Payment Network 120 of FIG. 1. The system 300 can include an application programming interface 310 (API), an incognito module 315, a payment card transaction module 320, and a session details storage 325. The API 310 can be used to communicate with and receive requests from entities outside the system 300. The incognito module 315 can be used to handle various aspects of payments during an incognito session, for example tracking whether the incognito session is active, interpreting data sent from the API 310, and sending incognito session details to the payment card transaction module 320. The payment card transaction module 320 can be used to interface with the other parties of a credit card transaction, such as the acquirer 115, issuer 230, and merchant 210. The payment card transaction module 320 can also send and receive requests to and from the incognito module 315 and the session details storage for determining whether a transaction falls within an incognito session. The session details storage 325 can be used to store details regarding an incognito session. The details stored can include the parameters, such as duration, what data to save, and details about the request such as time and location of the Cardholder/Customer at the time the session is initiated. Storing the data in a storage can allow for easier access of the data by the payment card transaction module 320 during a transaction.

Referring to FIG. 3A, an incognito session can begin by receiving a signal 331 to initiate an incognito session. As detailed in FIG. 2A-2C, this signal can originate from multiple sources including the Cardholder 200, Merchant 210, and Issuer 230. The signal 331 can be received via API 310. There may be multiple APIs available at the system for the incognito sessions depending on implementation. The signal 331 received via API 310 can be used by the incognito module 315 (either directly or after some processing that may be possible via the API 310). The incognito module 315 can store details about the incognito session, including duration (e.g. either a time period, number of transactions, or amount spent), accounts on which to initiate an incognito session, and types of data to save. At some point of time that can be triggered based on the details set up for the incognito session, the incognito module 315 can send a signal 333 to the payment card transaction module 320 that indicates an active incognito session. If the session details storage 325 is used to hold the details about the incognito session, these can be stored, sent either from the incognito module 315 or the payment card transaction module 320.

Referring to FIG. 3B, a payment 341 can be received by the system 300. Receipt of the signal to initiate a transaction can be handled according to existing processes, (e.g. as detailed in FIG. 1), and the payment card transaction module 320 can match the payment details with an account to find the issuing bank associated with the account. When the payment is received, the payment card transaction module 320 can also be configured to check if an incognito session is active.

In one implementation, such as shown in FIG. 3C, the payment card transaction module 320 can send a request 351 to the incognito module 315. The incognito module 315 can determine if an incognito session is active and return a response 352 with an appropriate indicator or flag. In another implementation (not shown), status of an incognito session can be stored in the session details storage 325. The payment card transaction module 320 can request the status (or otherwise look up details) from the session details storage 325 to determine if an incognito session is active. If an incognito session is active, an incognito payment 353 can be communicated to the Issuer 230. The incognito payment can comprise the payment request and an indication that the transaction is an incognito transaction. The indication can be, for example, a flag sent along with the payment details. In some cases, information regarding what types of details that need obscuring/removal is included. In some cases, information regarding the triggers for session timeout is included.

The Issuer 230 can receive and process the payment details, including performing requested preauthorization and/or authorization, according to the process outlined in FIG. 1. When the transaction is processed, the Issuer 230 can send a payment result to the Payment network. Referring to FIG. 3D, when the payment result 361 is received, the payment card transaction module 320 can also be configured to check if an incognito session is still active or if an incognito session was at least active when the payment was initially received.

In one implementation, such as shown in FIG. 3E, the payment card transaction module 320 can send a request 371 to the incognito module 315. The incognito module 315 can determine if an incognito session is active and return a response 372 with an appropriate indicator or flag. In another implementation (not shown), status of an incognito session can be stored in the session details storage 325. The payment card transaction module 320 can request the status (or otherwise look up details) from the session details storage 325 to determine if an incognito session is active. If an incognito session is active, an incognito payment result 373 can be forwarded to the Merchant 210 (e.g., via Acquirer 115). An incognito payment result can comprise the payment result and an indication that the transaction is an incognito transaction. The indication can be, for example, a flag sent along with the payment result. In some cases, information regarding what types of details that need obscuring/removal is included. In some cases, information regarding the triggers for session timeout is included.

Referring to FIG. 3F, at the end of the incognito session, the incognito module 315 can send a signal 381 to the payment card transaction module 320. This can trigger the clean incognito payment process as described in FIG. 2A.

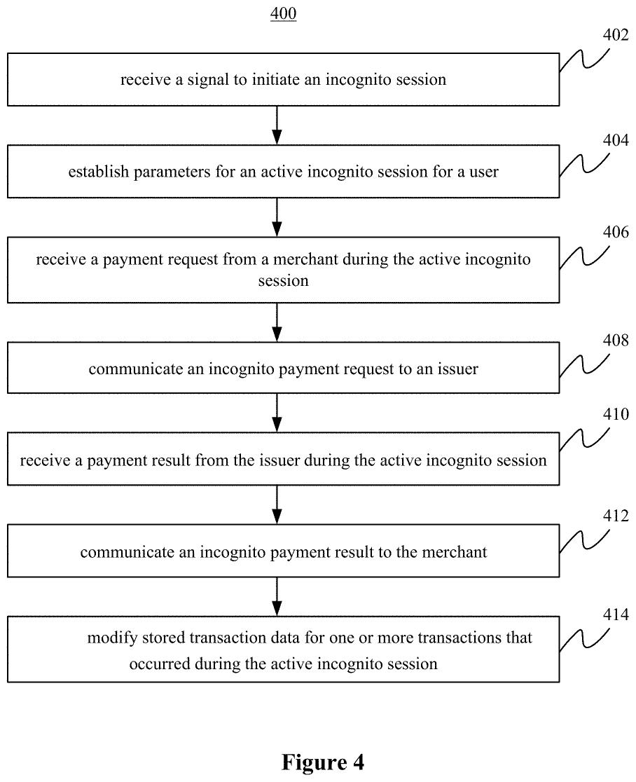

FIG. 4 illustrates a method for incognito transactions. Referring to FIG. 4, the process 400 can begin with receiving (402) a signal to initiate an incognito session. As discussed in FIGS. 2A-2C, the source of this signal can be from any of multiple sources, including the Cardholder 200, Merchant 210, and Issuer 230. In response to receiving the signal to initiate the incognito session, parameters can be established (404) for an active incognito session for a user. The parameters can be established by parsing data received with the signal. The parameters can include ways of determining whether an incognito session is active, include a start time and an end time, a total number of transactions, a total amount to be spent by the user, and a one or more merchant identifiers.

At some point in time, a payment request can be received (406) from a merchant during the active incognito session for the user. In response to receiving the payment request during the active incognito session, the system can communicate (408) an incognito payment request. The incognito payment request includes at least the payment request from the merchant and an indication of an incognito session for the Issuer. The indication of an incognito session for the Issuer can be, for example, a flag added to existing data elements included in the payment request.

A payment result can be received (410) from the Issuer during the active incognito session. In response to receiving the payment result during the active incognito session, the system can communicate (412) an incognito payment result. The incognito payment result includes at least the payment result from the Issuer and an indication of an incognito session for the merchant. The indication of an incognito session for the Issuer can be, for example, a flag added to existing data elements included in the payment result.

Transaction data can later be modified (414) for one or more transactions that occurred during the active incognito session. Timing of the modification can vary. For instance, all modifications could occur when the active incognito session is terminated. There may also be some other trigger to begin modification. For instance, if an incognito session persists for more than a month (e.g. if one is traveling abroad), a statement may be prepared before the incognito session is terminated. In this case, modifications could occur prior to the statement being prepared. Specifics of the modifications can be determined by the parameters set during the initiation of the incognito session. Fields that can be modified can include date, transaction details, and amount. One or more field can be selected to be modified. The modification can comprise deleting the selected fields or encrypting the selected fields.

FIG. 5A-D illustrates example payment card statements resulting from incognito card transactions. FIG. 5A shows an example payment card statement with no incognito card transactions. FIGS. 5B and 5C show example payment card statements in which some purchases occurred during an incognito session with various implementations of partial data obscuring. FIG. 5D shows an example payment card statement in which some purchases occurred during an incognito session with full data obscuring. The payment card statement can be a reflection of transactions using the payment card over a period of time, e.g. a month.

Referring to FIG. 5A, an example payment card statement without any incognito session can be seen. The payment card statement can be divided into a number of parts: account summary, transaction log, and payment summary. The account summary can include an overview of an account, possibly including details such as balance before and after the period of time. The account summary can also include a sum of total charges and payments made from and to the account. The transaction log can be a listing of each transaction involving a payment card associated with the account. The listing of each transaction can include details about the transaction, including date, a reference number for internal use, a transaction detail, a name of the merchant in the transaction, and an amount of the transaction. The payment summary can include a credit limit and an amount of available credit.

Referring to FIGS. 5B and 5C, there are various ways an incognito session can be reflected in a payment card statement. In an incognito session, one or more of the fields can be specified to be obscured, deleted, or encrypted. An amount of obscuring and which fields to obscure can be determined as parameters when the incognito session is initiated. For example, the transaction details or amount can be obscured. FIG. 5B shows a payment card statement in which the Transaction details of location are obscured. This might be useful, for example, when shopping for a gift. Even if a person has access to your account, say a spouse or parent, the person would be unable to determine the gift without the location of the transaction. FIG. 5C shows another possible implementation, wherein the amount is obscured. Referring to FIG. 5D, multiple fields can be obscured simultaneously. For example, both transaction details and amount can be obscured simultaneously. In these illustrated examples, the obscuring in the statement is shown as a note. However, the statement may reflect the obscuring in any suitable manner and does not necessarily reflect the manner in which the data is stored by the issuer. For example, the issuer may store null data in the fields where the information was cleaned.

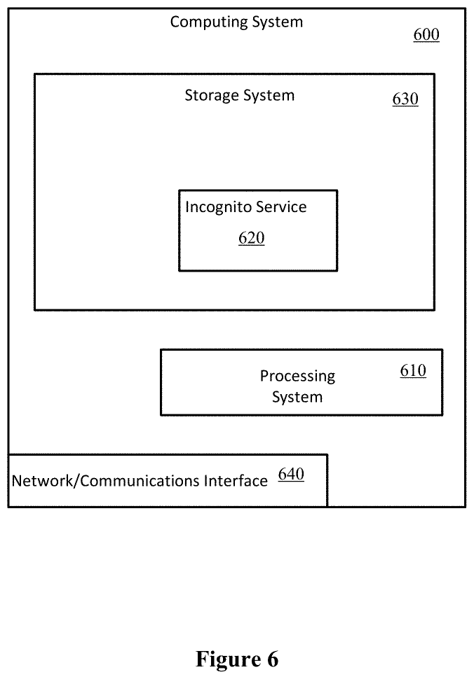

FIG. 6 illustrates components of a computing system that may provide an incognito service as described herein. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 600 can include a processing system 610, which may include one or more processors and/or other circuitry that retrieves and executes software for an incognito service 620 from storage system 630. Processing system 610 may be implemented within a single processing device but may also be distributed across multiple processing devices or sub-systems that cooperate in executing program instructions.

Storage system(s) 630 can include any computer readable storage media readable by processing system 610 and capable of storing software for the incognito service 620. Storage system 630 may be implemented as a single storage device but may also be implemented across multiple storage devices or sub-systems co-located or distributed relative to each other. Storage system 630 may include additional elements, such as a controller, capable of communicating with processing system 610. Storage system 630 may also include storage devices and/or sub-systems on which data is stored. System 600 may access one or more storage resources in order to obtain information to carry out any of the processes indicated by incognito service 620.

Software for the incognito service 620, including routines for performing processes such as described in FIGS. 2A-2C and process 400 described with respect to FIG. 4 may be implemented in program instructions and among other functions may, when executed by system 600 in general or processing system 610 in particular, direct the system 600 or processing system 610 to operate as described herein.

Communication interface 640 may be included, providing communication connections and devices that allow for communication between system 600 and other computing systems (not shown) over a communication network or collection of networks (not shown) or the air.

In embodiments where the system 600 includes multiple computing devices, the system 600 can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

In some embodiments, system 600 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for incognito transactions, the method comprising:
receiving a signal to initiate an incognito session;
in response to receiving the signal to initiate the incognito session, establishing parameters for an active incognito session for a user,
receiving a payment request from a merchant during the active incognito session;
in response to receiving the payment request during the active incognito session, communicating an incognito payment request to an issuer, the incognito payment request comprising at least the payment request from the merchant and an indication of an incognito session for the issuer;
receiving a payment result from the issuer during the active incognito session;
in response to receiving the payment result during the active incognito session, communicating an incognito payment result to the merchant, the incognito payment result comprising at least the payment result from the issuer and an indication of an incognito session for the merchant; and
modifying stored transaction data for one or more transactions that occurred during the active incognito session.

2. The method of claim 1, wherein establishing the parameters for an active incognito session comprises:
parsing data received with the signal to determine parameters for the incognito session.

3. The method of claim 2, further comprising:
determining when the incognito session is active based on one or more parameters of the parameters for the active incognito session.

4. The method of claim 3, wherein the one or more parameters include a start time and an end time.

5. The method of claim 3, wherein the one or more parameters include a total number of transactions.

6. The method of claim 3, wherein the one or more parameters include a total amount to be spent by the user.

7. The method of claim 3, wherein the one or more parameters include one or more merchant identifiers.

8. The method of claim 1, wherein modifying the stored transaction data comprises deleting one or more fields related to a transaction.

9. The method of claim 8, wherein the fields related to the transaction are one or more of merchant, date, transaction details, and amount.

10. The method of claim 1, wherein modifying the stored transaction data comprises encrypting one or more fields related to a transaction.

11. The method of claim 10, wherein the fields related to the transaction are one or more of merchant, date, transaction details, and amount.

12. The method of claim 1, wherein the indication of an incognito session for the issuer includes which fields to modify; and
wherein the indication of an incognito session for the merchant includes which fields to modify.

13. The method of claim 1, wherein the signal to initiate an incognito session is received from the user.

14. The method of claim 1, wherein the signal to initiate an incognito session is received from the issuer.

15. The method of claim 1, wherein the signal to initiate an incognito session is received from the merchant.

16. A system for providing incognito transactions, comprising:
a processing system;
a storage system; and
instructions stored on the storage system that when executed by the processing system direct the system for providing incognito transactions to at least:
in response to receiving a signal to initiate an incognito session, establish parameters for an active incognito session for a user,
receive a payment request from a merchant during the active incognito session;
in response to receiving the payment request during the active incognito session, communicate an incognito payment request to an issuer, the incognito payment request comprising at least the payment request from the merchant and an indication of an incognito session for the issuer;
receive a payment result from the issuer during the active incognito session;
in response to receiving the payment result during the active incognito session, communicate an incognito payment result to the merchant, the incognito payment result comprising at least the payment result from the issuer and an indication of an incognito session for the merchant; and
modify stored transaction data for one or more transactions that occurred during the active incognito session.

17. The system of claim 16, wherein the instructions further direct the system for providing incognito transactions to:
determine when the incognito session is active based on one or more parameters of the parameters for the active incognito session.

18. The system of claim 17, wherein the one or more parameters include a start time and an end time; a total number of transactions; a total amount to be spent by the user; or one or more merchant identifiers.

19. The system of claim 16, wherein the instructions to modify the stored transaction data direct the system for providing incognito transactions to:
delete one or more fields related to a transaction.

20. The system of claim 16, wherein the instructions to modify the stored transaction data direct the system for providing incognito transactions to:
encrypt one or more fields related to a transaction.
